(19) United States
(12) Patent Application Publication
(10) Pub. No.: US 2024/0134673 A1
(43) Pub. Date: Apr. 25, 2024

(54) SUB-TRANSPORT NODE PROFILE CONFIGURATIONS FOR A CLUSTER OF HOSTS

(71) Applicant: VMWARE, INC., Palo Alto, CA (US)

(72) Inventors: RADHA SRINIVASAN, Bangalore (IN); NILESH GANU, Pune (IN); AKSHATHA V P, Bangalore, (IN); ANSHUL GOYAL, Bangalore (IN); RAMACHANDRAN THIRUPATHI, Madurai (IN)

(21) Appl. No.: 18/086,809

(22) Filed: Dec. 22, 2022

(30) Foreign Application Priority Data
Oct. 24, 2022 (IN) 202241060686

(51) Int. Cl. G06F 9/455

(52) U.S. Cl. CPC G06F 9/45558; G06F 2009/4557; G06F 2009/45583; G06F 2009/45595

(57) ABSTRACT

The disclosure provides an example method for configuring a cluster of hosts. The method generally includes defining a global transport node profile that defines a first configuration for the cluster of hosts, defining a sub-transport node profile that defines a second configuration, assigning one or more hosts of the cluster to the sub-transport node profile and configuring the cluster of hosts based on the global transport node profile and the sub-transport node profile comprising: configuring the one or more hosts of the cluster based on the first configuration and the second configuration; and configuring at least one host of the cluster not assigned to the sub-transport node profile based on the first configuration and not the second configuration.

### RELATED APPLICATION

Benefit is claimed under 35 U.S.C. 119(a)-(d) to Foreign Application Serial No. 202241060686 filed in India entitled “SUB-TRANSPORT NODE PROFILE CONFIGURATIONS FOR A CLUSTER OF HOSTS”, on Oct. 25, 2022 by VMware, Inc., which is herein incorporated in its entirety by reference for all purposes.

### BACKGROUND

Software defined networking (SDN) involves a plurality of hosts in communication over a physical network infrastructure of a data center (e.g., an on-premise data center or a cloud data center). The physical network to which the plurality of physical hosts are connected may be referred to as an underlay network. Each host has one or more virtualized endpoints such as virtual machines (VMs), containers, Docker containers, data compute nodes, isolated user space instances, namespace containers, and/or other virtual computing instances (VCIs). The VMs running on the hosts may communicate with each other using an overlay network established by hosts using a tunneling protocol. Though certain aspects are discussed herein with respect to VMs, it should be noted that the techniques may apply to other suitable VCIs as well.

As part of an SDN, any arbitrary set of VMs in a datacenter may be placed in communication across a logical Layer 2 (L2) overlay network by connecting them to a logical switch. A logical switch is an abstraction of a physical switch that is collectively implemented by a set of virtual switches on each host that has a VM connected to the logical switch. The virtual switch on each host operates as a managed edge switch implemented in software by a hypervisor on each host. Virtual switches provide packet forwarding and networking capabilities to VMs running on the host. In particular, each virtual switch uses hardware based switching techniques to connect and transmit data between VMs on a same host, or different hosts.

A virtual local area network (VLAN) is any broadcast domain that is partitioned and isolated to a logical segment of an L2 network. To accomplish this, an L2 switch can assign VLANs to specific switch ports. Any egress packet arriving at the port that is tagged with a particular VLAN identifier may be dropped by the switch if the VLAN tag does not match the VLAN assigned to the port. This prevents endpoints from receiving packets not associated with the VLAN that the endpoint is associated with. By assigning different VLAN identifiers to different endpoints and their corresponding switch ports, a single L2 network may be logically partitioned into different broadcast domains.

In some cases, a switch port assigned to a VLAN is a port of a top-of-rack (ToR) switch. The port is a physical interface that can be connected to a physical server using an ethernet cable. ToR switching is a data center architecture design in which computing equipment such as hosts, other switches, etc. located within a same, or adjacent, rack are connected to an in-rack network switch. Each ToR switch, and accordingly VLANs assigned to the ports of the ToR switch, may exist in its own L3 network subnet. As such, to allow for traffic to flow between different VLANs, ToR switches of different racks may be connected via a dynamic routing protocol. For example, L2 connectivity is limited within a data center rack up to the ToR switch. The ToR switch terminates each VLAN and provides default Layer 3 gateway functionality to enable communication between hosts attached to different VLANs.

A cluster of hosts (e.g., a group of hosts configured to share resources) on racks connected to a same, or different, ToR switch(es) (and thus in a same subnet and/or different subnets), may be associated with a transport node profile that defines a configuration that is applied to the cluster. For example, a transport node profile may define one or more virtual switches and the virtual switches' configurations. The virtual switch configuration includes a virtual switch type and a virtual switch mode setting. The transport node profile may also define one or more transport zones. A transport zone defines which hosts are spanned by a logical switch. In other words, the transport zone for a logical L2 network is defined by the set of hosts having at least one virtual machine (or container, etc.) attached to the logical network. A particular host may be associated with as many different transport zones as there are VMs on the host if each of the VMs are attached to a different overlay network. The transport node profile may include a network input/output configuration (NIOC). The NIOC is used to implement a Quality-of-Service (QoS) on network traffic by allowing a user or administrator to prioritize bandwidth for traffic on certain network resources, such as physical network interface cards (PNICs) connected to the virtual switch. The transport node profile may also include an uplink profile. The uplink profile indicates which PNICs and which virtual NICs (VNICs), also referred to as “virtual interfaces,” of a set of virtual machines running on the host are connected to which virtual ports (vports) on the virtual switch. The transport node profile may also include one or more Layer 2 (L2) networking configurations including a link layer discovery protocol (LLDP) profile, an IP assignment profile, and a teaming policy. The LLDP profile is used to advertise attributes of the virtual switch. The LLDP profile may be set to a listen mode, an advertise mode, or both. The teaming policy dictates how the virtual switch uses its uplinks for load balancing and redundancy.

In some cases, configuring hosts of the cluster, situated on different racks and connected to different ToR switches (e.g., across multiple subnets), with a transport node profile defined for the cluster is a difficult task for users and/or administrators. For example, as mentioned above, a transport node profile associated with a cluster of hosts may include uplink profile(s). Each uplink profile is associated with only one subnet/VLAN/IP pool; however, the cluster of hosts may be stretched across multiple subnets/VLANs/IP pools as different hosts of the cluster may be in different subnets/VLANs/IP pools. Accordingly, the configuration defined by the transport node profile may be applied to all hosts in the cluster (e.g., a common set of parameters may be applied to all hosts), and as a workaround, users and/or administrators may subsequently edit the uplink profile for each host in the cluster based on the subnet/VLAN/IP pool for which the host belongs to. In other words, users and/or administrators may take additional manual steps to override the configuration on each individual host to correct the uplink profile for each host.

First, determining which hosts of the cluster need to be updated after the transport node profile is applied to the cluster is cumbersome. In particular, a user and/or administrator may not be able to determine the configuration of a particular host without first accessing that particular host. Accessing each host in the cluster to determine whether the configuration for the host needs to be updated, based at least in part on the subnet associated with the host and/or other properties of the host, is a tedious task where a host cluster contains multiple hosts.

Second, changes to the transport node profile applied to the hosts in the cluster may occur after configuration. The changes may apply to less than all hosts in the cluster. A single location for implementing the change to less than all hosts of the cluster is not currently provided. As such, a user and/or administrator may need to access and update each individual host when an update occurs for multiple hosts of the cluster.

Third, application of this manual update in a large scale environment may be more prone to error. Human errors in manual data entry are naturally unintentional, however inevitable. Errors which result in the wrong configuration for one or more hosts of the cluster may lead to an inability of hosts within the cluster to communicate, and more specifically, engage in packet forwarding/receipt between hosts and/or VMs running on each of the hosts in the cluster.

### SUMMARY

One or more embodiments provide a method for configuring a cluster of hosts. The method generally includes defining a global transport node profile that defines a first configuration for the cluster of hosts, defining a sub-transport node profile that defines a second configuration, assigning one or more hosts of the cluster to the sub-transport node profile and configuring the cluster of hosts based on the global transport node profile and the sub-transport node profile comprising: configuring the one or more hosts of the cluster based on the first configuration and the second configuration; and configuring at least one host of the cluster not assigned to the sub-transport node profile based on the first configuration and not the second configuration.

Further embodiments include a non-transitory computer-readable storage medium storing instructions that, when executed by a computer system, cause the computer system to perform the method set forth above, and a computer system including at least one processor and memory configured to carry out the method set forth above.

### BRIEF DESCRIPTION OF THE DRAWINGS

FIG. 1 is a block diagram of an exemplary data center, according to one or more aspects of the present disclosure.

FIGS. 2A and 2B are flow diagrams illustrating example operations for configuring hosts, of a cluster, having different properties with a transport node profile defined for the cluster, according to one or more aspects of the present disclosure.

FIG. 3 illustrates an example transport node profile comprising sub-transport node profiles defined for a cluster of hosts, according to one or more aspects of the present disclosure.

FIG. 4 illustrates an example assignment of hosts of a first and second cluster to various sub-clusters, according to one or more aspects of the present disclosure.

FIG. 5 illustrates example configuration of hosts of the first cluster based on a transport node profile defined for the first cluster, according to one or more aspects of the present disclosure.

FIG. 6 is a flow diagram illustrating example operations for updating the configuration applied to hosts belonging to a sub-cluster, according to one or more aspects of the present disclosure.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Aspects of the present disclosure provide techniques for configuring a cluster of hosts based on a global transport node profile. The global transport node profile described herein defines a first configuration that is be applied to the cluster of hosts. Further, the global transport node profile includes one or more sub-transport node profiles, where each sub-transport node profile defines a second configuration to be applied to a group of hosts of the cluster, that is less than all of the hosts of the cluster.

For example, a plurality of hosts may be logically grouped into a host cluster to provide cluster-level functions to hosts of the cluster, such as VM migration between hosts in the cluster (e.g., for load balancing), distributed power management, dynamic VM placement according to affinity and anti-affinity rules, high availability, and/or the like. Hosts of the cluster may be geographically co-located servers on the same or different racks in a data center. A top-of-Rack (ToR) switch may be connected to one or more of the racks to allow for communication and routing of traffic between computing devices (e.g., including hosts) on racks connected to different ToR switches. Each ToR switch, and correspondingly each host connected to the ToR switch, may belong to a particular layer 3 (L3) network domain, or in other words, exist in a unique subnet.

One or more hosts of the cluster may be assigned to (e.g., grouped into) one or more sub-clusters (e.g., having one or more hosts). Hosts assigned to a sub-cluster may share a common property among other hosts assigned to the sub-cluster. For example, in some cases, hosts assigned to a sub-cluster may be hosts of the cluster which share a same ToR switch, and accordingly, belong to a same subnet. Although each sub-cluster may correspond to a particular subnet and therefore include only hosts belonging to the particular subnet, it is also possible for sub-clusters to be defined based on other properties associated with the hosts in the subcluster.

A sub-transport node profile may be defined for each of the different sub-clusters. Each sub-transport node profile generated for a corresponding sub-cluster may define unique configurations to be applied to hosts of the sub-cluster. For example, a first sub-transport node profile to be applied to a first sub-cluster of hosts may define one or more parameters, such as virtual switches, transport zones, uplink profiles, etc., different than a second sub-transport node profile to be applied to a second sub-cluster of hosts. Further, a global transport node profile may define a configuration to be applied to all hosts of the cluster. The global transport node profile may define one or more parameters, such as virtual switches, transport zones, uplink profiles, etc.

Hosts of the host cluster may be configured based on the global transport profile, having the sub-transport node profiles defined therein. As such, a host belonging to the cluster and assigned to a sub-cluster may be configured based on parameters defined in both the global transport node profile and a sub-transport node profile associated with the sub-cluster of the host. Where parameters of the sub-transport node profile conflict with parameters of the global transport node profile, conflicting parameters defined by the sub-transport node profile may be applied to the host.

As such, the techniques described herein allow a user and/or administrator to define one or more transport node profile configurations for a cluster of hosts. Further, the techniques and systems described herein allow the user and/or administrator to configure a cluster of hosts with various configuration parameters of the defined transport node profile configurations. Accordingly, hosts of a cluster may be configured with different parameters based on the application of a single, global transport node profile. This may allow for simpler transport node profile configuration in large-scale deployments where different configuration parameters are desired for different hosts of the cluster. Further, where a configuration for hosts of a sub-cluster is to be updated, a sub-transport node profile associated with the sub-cluster may be updated as opposed to updating the configuration at each individual host, thereby resulting in a more efficient update, less susceptible to human errors. Reducing the propensity for error may help to ensure that communication between hosts is possible.

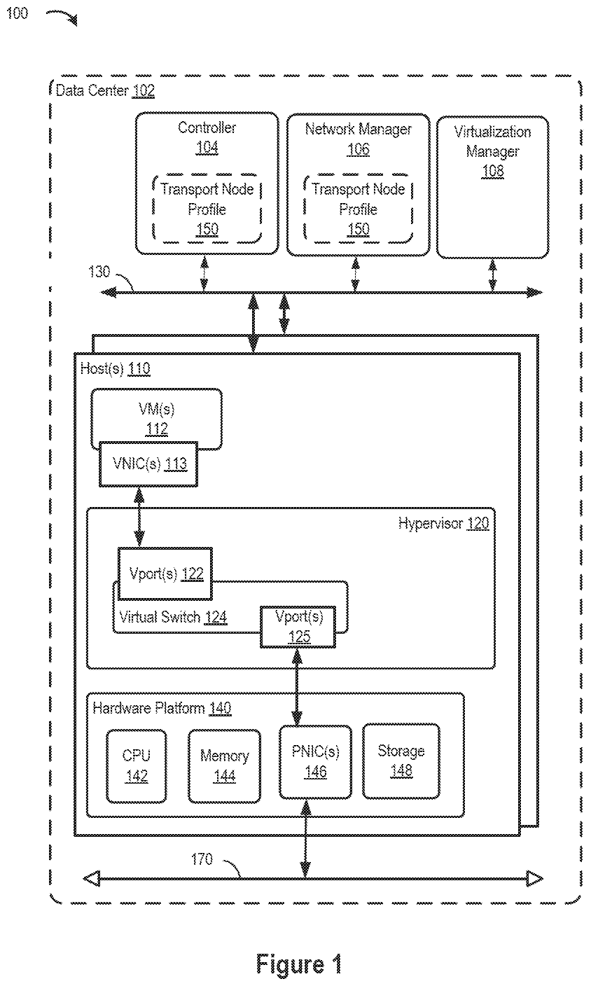

FIG. 1 depicts example physical and virtual network components in a networking environment 100 in which embodiments of the present disclosure may be implemented.

Networking environment 100 includes a data center 102. Data center 102 includes one or more hosts 110, a management network 130, a data network 170, a controller 104, a network manager 106, and a virtualization manager 108. Data network 170 and management network 130 may be implemented as separate physical networks or as separate virtual local area networks (VLANs) on the same physical network.

Host(s) 110 may be communicatively connected to data network 170 and management network 130. Data network 170 and management network 130 are also referred to as physical or “underlay” networks, and may be separate physical networks or the same physical network as discussed. As used herein, the term “underlay” may be synonymous with “physical” and refers to physical components of networking environment 100. As used herein, the term “overlay” may be used synonymously with “logical” and refers to the logical network implemented at least partially within networking environment 100.

Host(s) 110 may be geographically co-located servers on the same rack or on different racks in any arbitrary location in the data center. Host(s) 110 may be configured to provide a virtualization layer, also referred to as a hypervisor 120, that abstracts processor, memory, storage, and networking resources of a hardware platform 140 into multiple VMs 112 (only one shown).

Host(s) 110 may be constructed on a server grade hardware platform 140, such as an x86 architecture platform. Hardware platform 140 of a host 110 may include components of a computing device such as one or more processors (CPUs) 142, system memory 144, one or more network interfaces (e.g., physical network interface cards (PNICs) 146), storage 148, and other components (not shown). A CPU 142 is configured to execute instructions, for example, executable instructions that perform one or more operations described herein and that may be stored in the memory and storage system. The network interface(s) enable host 110 to communicate with other devices via a physical network, such as management network 130 and data network 170.

Hypervisor 120 includes one or more virtual switches 124. A virtual switch 124 may be a virtual switch attached to a default port group defined by network manager 106 and provide network connectivity to a host 110 and VMs 112 on the host. Port groups include subsets of virtual ports of a virtual switch, each port group having a set of logical rules according to a policy configured for the port group. Each port group may comprise a set of virtual ports associated with one or more virtual switches on one or more hosts. Ports associated with a port group may be attached to a common VLAN according to the IEEE 802.1Q specification to isolate the broadcast domain. Network manager 106 configures and maintains each standard virtual switch 124 individually for hosts 110. A virtual switch 124 has a virtual switch profile. The virtual switch profile includes a name of the virtual switch, a manufacturer, a version, a number of uplinks, an NIOC, a maximum transmission unit (MTU) size, a multicast filtering mode, a discovery type and operation status, and/or administrator contact information.

A virtual switch 124 may be a virtual distributed switch (VDS). In this case, each host 110 may implement a separate virtual switch corresponding to the VDS, but the virtual switches 124 at each host 110 may be managed like a single virtual distributed switch (not shown) across the hosts 110. A VDS can have multiple Layer 2 (L2) networking configuration profiles. An L2 networking configuration profile may include configuration details for logical switches and logical ports. For example, an L2 networking configuration profile can include a Quality-of-Service (QoS) profile, an IP address discovery profile, a security profile, and a medium access control (MAC) management profile. An L2 networking configuration profile can be used to provide high-quality and dedicated network performance for preferred traffic that requires a high bandwidth and high QoS and for allocating network bandwidth to business-critical applications.

Each of VMs 112 running on host 110 may include virtual interfaces, often referred to as virtual network interface cards (VNICs), such as VNICs 113, which are responsible for exchanging packets between VMs 112 and hypervisor 120. VNICs 113 can connect to virtual ports (“Vports”) 122, provided by virtual switch 124. In this context “connect to” refers to the capability of conveying network traffic, such as individual network packets, or packet descriptors, pointers, identifiers, etc., between components so as to effectuate a virtual datapath between software components. Virtual switch 124 also has Vport(s) 125 connected to PNIC(s) 146, such as to allow VMs 112 to communicate with virtual or physical computing devices outside of host 110 via data network 170 and/or management network 130.

Data center 102 may include a network management plane and a network control plane. The management plane and control plane each may be implemented as single entities (e.g., applications running on a physical or virtual compute instance), or as distributed or clustered applications or components. In alternative aspects, a combined manager/controller application, server cluster, or distributed application, may implement both management and control functions. In the embodiment shown, network manager 106 at least in part implements the network management plane and network controller 104 at least in part implements the network control plane.

The network control plane is a component of software defined network (SDN) infrastructure and determines the logical overlay network topology and maintains information about network entities such as logical switches, logical routers, endpoints, etc. The logical topology information is translated by the control plane into physical network configuration data that is then communicated to network elements of host(s) 110. Network controller 104 generally represents a network control plane that implements software defined networks, e.g., logical overlay networks, within data center 102. Network controller 104 may be one of multiple network controllers executing on various hosts in the data center that together implement the functions of the network control plane in a distributed manner. Network controller 104 may be a computer program that resides and executes in a server in the data center 102, external to data center 102 (e.g., such as in a public cloud) or, alternatively, network controller 104 may run as a virtual appliance (e.g., a VM) in one of hosts 110. Although shown as a single unit, it should be understood that controller 104 may be implemented as a distributed or clustered system. That is, network controller 104 may include multiple servers or virtual computing instances (VCIs) that implement controller functions. It is also possible for network controller 104 and network manager 106 to be combined into a single network controller/manager. Network controller 104 collects and distributes information about the network from and to endpoints in the network. Network controller 104 is associated with one or more virtual and/or physical CPUs (not shown). Processor(s) resources allotted or assigned to network controller 104 may be unique to network controller 104, or may be shared with other components of data center 102. Network controller 104 may communicate with hosts 110 via management network 130, such as through control plane protocols. In certain aspects, network controller 104 implements a central control plane (CCP) which interacts and cooperates with local control plane components, e.g., agents, running on hosts 110 in conjunction with hypervisors 120.

Network manager 106 and virtualization manager 108 generally represent components of a management plane comprising one or more computing devices responsible for receiving logical network configuration inputs, such as from a user or network administrator or automated orchestration system, defining one or more endpoints (e.g., VCIs) and the connections between the endpoints, as well as rules governing communications between various endpoints.

In certain aspects, virtualization manager 108 is a computer program that executes in a server in data center 102 (e.g., the same or a different server than the server on which network manager 106 executes), or alternatively, virtualization manager 108 runs in one of VMs 112. Virtualization manager 108 is configured to carry out administrative tasks for the data center, including managing hosts 110, managing (e.g., configuring, starting, stopping, suspending, etc.) VMs running within each host 110, provisioning VMs, transferring VMs from one host to another host, transferring VMs between data centers, transferring application instances between VMs or between hosts 110, and load balancing VMs among hosts 110 within a cluster. Virtualization manager 108 takes commands as to creation, migration, and deletion decisions of VMs and application instances on the data center. However, virtualization manager 108 also makes independent decisions on management of local VMs and application instances, such as placement of VMs and application instances between hosts 110. In certain aspects, virtualization manager 108 also includes a migration component that performs live migration of VMs between hosts 110, which involves transferring a VM from one host to another without significant downtime by transferring state of a VM between two hosts while the VM is running.

In certain aspects, network manager 106 is a computer program that executes in a server in networking environment 100, or alternatively, network manager 106 may run in a VM 112, e.g., in one of hosts 110. Network manager 106 communicates with host(s) 110 via management network 130. Network manager 106 may receive network configuration input from a user, such as an administrator, or an automated orchestration platform (not shown) and generate desired state data that specifies logical overlay network configurations. For example, a logical network configuration may define connections between VCIs and logical ports of logical switches. Network manager 106 is configured to receive inputs from an administrator or other entity, e.g., via a web interface or application programming interface (API), and carry out administrative tasks for data center 102, including centralized network management and providing an aggregated system view for a user.

In certain aspects, network configuration input includes a transport node profile 150 (also referred to herein as a “global transport node profile”). Transport node profile 150 defines a first configuration that is to be applied to a cluster of hosts. For example, a set of hosts 110 of data center 102 may be logically grouped into a host cluster. A user and/or administrator may define a transport node profile 150 to be applied to hosts 110 in the cluster. The transport node profile 150 may define transport zones, member hosts, VDS switch configurations including uplink profiles, IP assignments, mapping of physical NICs to uplink virtual interfaces, and/or the like. The transport node profile 150 may be stored as a file, such as a YAML file, such as in a memory or storage of controller 104 and/or network manager 106.

In addition, transport node profile 150 may include one or more sub-transport node profiles. Though certain aspects are described as sub-transport node profiles being defined in a global transport node profile, such as transport node profile 150, meaning they may be defined and stored in the same file as transport node profile 150, it should be understood that the sub-transport node profiles may be defined and stored in one or more separate files than the global transport node profile. Similar to parameters defined for transport node profile 150, the sub-transport node profile(s) also defines configuration parameters, such as transport zones, uplink profiles, etc., to be applied to hosts 110 of the cluster. However, the sub-transport node profile defines configuration parameters to be applied to a particular grouping or subset of hosts 110 in the cluster (e.g., a sub-cluster) without applying to all hosts 110 in the cluster. The subcluster may include any number of hosts of the cluster but is particularly useful for applying configurations only to less than all of the hosts in the cluster based on a characteristic, context, or designation particular to those hosts.

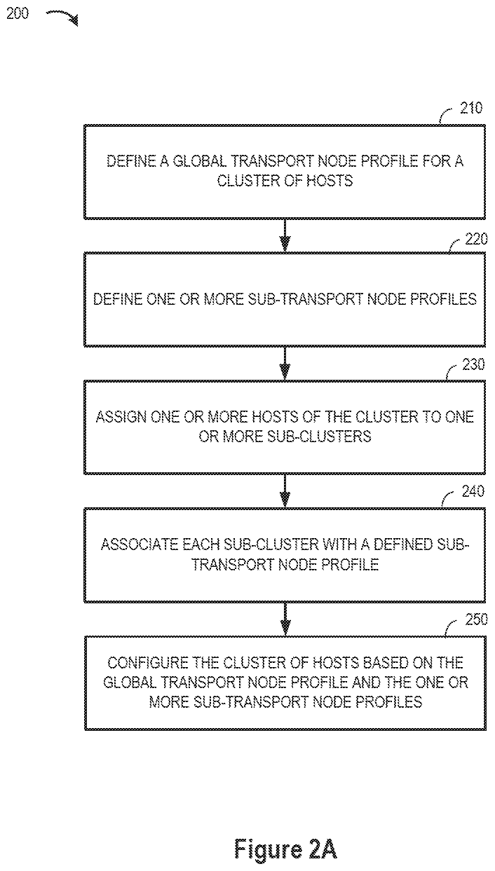

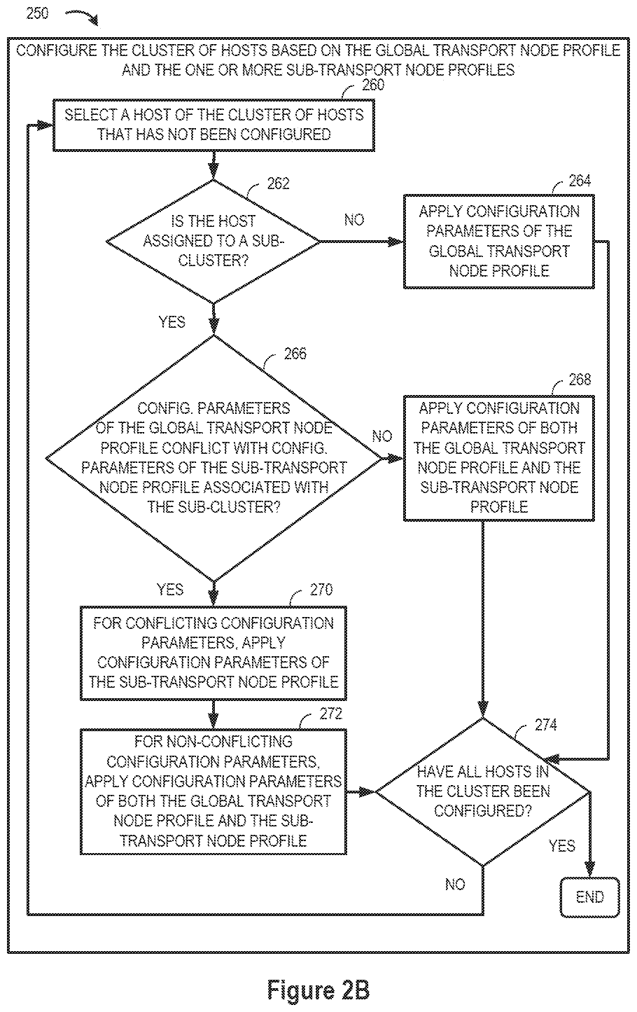

In certain aspects, the transport node profile received by network manager 106 can be used by controller 104 to configure hosts 110 in the cluster. Controller 104 configures hosts 110 based on parameters defined in transport node profile 150 for all hosts 110, and in some cases, parameters defined in a sub-transport node profile of profile 150 when the host 110 being configured belongs to a sub-cluster associated with the sub-transport node profile. Defining the transport node profile, defining one or more sub-transport node profiles for the transport node profile, and configuring hosts based on the global transport node profile is described in detail with respect to FIGS. 2A and 2B.

FIGS. 2A and 2B are flow diagrams illustrating example operations 200 for configuring hosts, of a cluster, having different properties with a transport node profile defined for the cluster, according to one or more aspects of the present disclosure. In particular, operations 200 provide a method for configuring hosts of a cluster with different configuration parameters based on the application of a single, transport node profile. Operations 200 may be performed by a user and/or administrator, as well as controller 104 and network manager 106 illustrated in FIG. 1 to configure hosts 110 of a cluster.

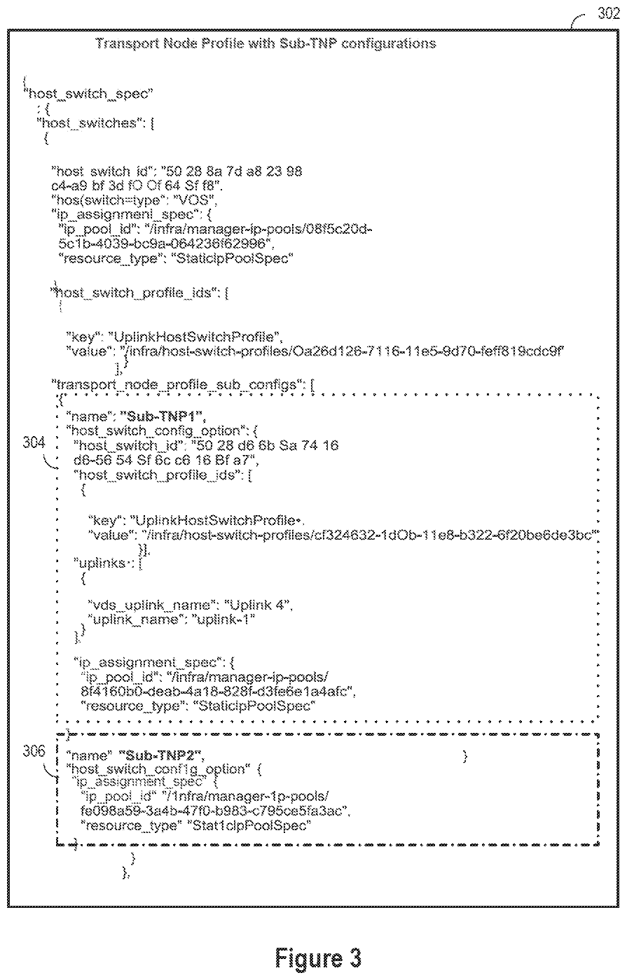

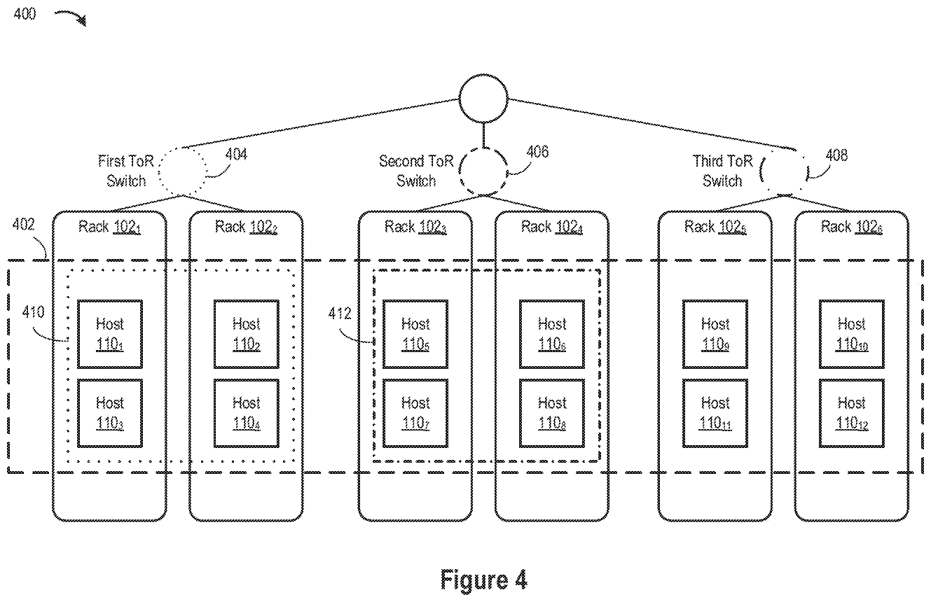

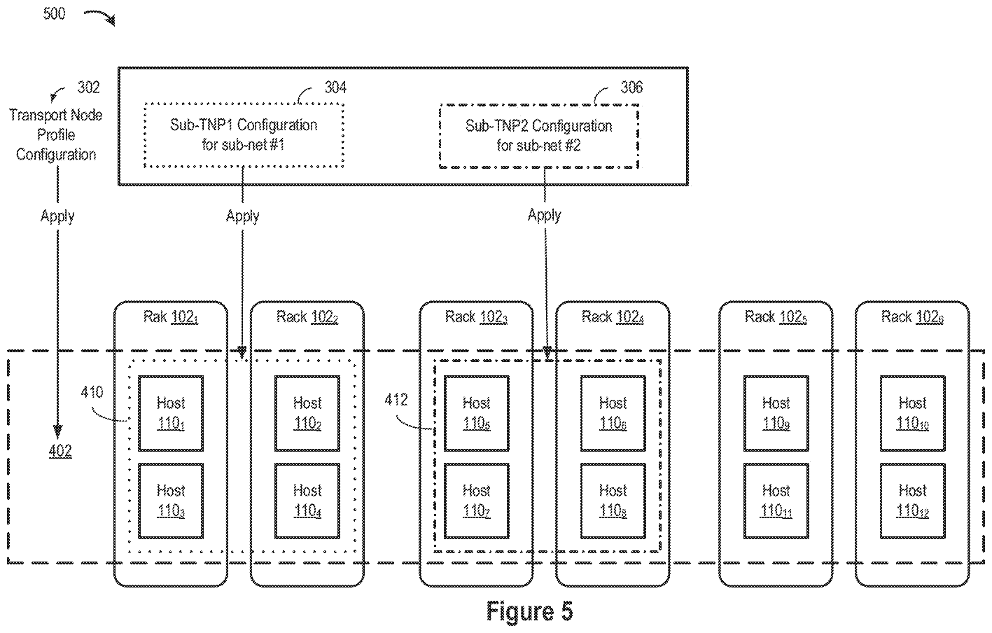

For ease of explanation, operations 200 may be described with respect to the example illustrated in FIGS. 3, 4, and 5. In particular, FIG. 3 illustrates an example transport node profile comprising sub-transport node profiles that may be defined for a first cluster of hosts, according to one or more aspects of the present disclosure. FIG. 4 illustrates an example assignment of hosts of the first cluster and a second cluster to various sub-clusters, according to one or more aspects of the present disclosure. Further, FIG. 5 illustrates example configuration of hosts of the first cluster based on the transport node profile defined for the first cluster in FIG. 3, according to one or more aspects of the present disclosure.

As illustrated, operations 200 begin at block 210, by defining a global transport node profile (e.g., a first configuration) for a cluster of hosts. The global transport node profile may be defined by a user and/or an administrator, and may be stored in a file. For example, a global transport node profile defined by a user and/or an administrator may be similar to the example global transport node profile 302 illustrated in FIG. 3. As illustrated, example global transport node profile 302 identifies a configuration parameter, “IP pool IDs” (e.g., “ip_pool_id”), to be applied to all hosts in the cluster. In some other examples, one or more other configuration parameters, such as virtual switches, virtual switch configurations, transport zones, network input/output configurations, and/or uplink profiles, may be defined in addition to, or alternative to, “IP pool IDs” in global transport node profile 302 for application to all hosts 110 in the cluster.

At block 220, operations 200 proceed with defining one or more sub-transport node profiles. In certain aspects, the one or more sub-transport node profiles may be defined in the global transport node profile, such as defined and stored in the same file as the global transport node profile. In certain aspects, the one or more sub-transport node profiles may be defined and stored in one or more separate files from the global transport node profile. Configuration parameters defined for the sub-transport node profile(s) may be the same and/or different to configuration parameters defined for the global transport node profile. As further explained below with reference to FIG. 2B, if the same parameter is defined for both the global transport and sub-transport node profiles, then the sub-transport node profile takes precedence for hosts that are a member of the sub-cluster associated with the sub-transport node profile. Further, configuration parameters defined for each of the sub-transport node profiles, where more than one sub-transport node profile is defined, may be the same and/or different to configuration parameters defined for another sub-transport node profile. For example, as illustrated in FIG. 3, a first sub-transport node profile 304 (e.g., “Sub-TNP1”) and a second sub-transport node profile 306 (e.g., “Sub-TNP2”) may be defined for global transport node profile 302. Configuration parameters defined for first sub-transport node profile 304 include “IP pool IDs” (e.g., “ip_pool_id”) and a “VDS uplink” (e.g., “vds_uplink_name” and “uplink_name”). A configuration parameter defined for second sub-transport node profile 306 includes “IP pool IDs” (e.g., “ip_pool_id”).

At block 230, operations 200 proceed with assigning one or more hosts of the cluster (e.g., for which the global transport node profile is defined) to one or more sub-clusters. In particular, the cluster of hosts may be partitioned into one or more sub-clusters. Each host of the cluster may be assigned to a particular sub-cluster until all hosts of the cluster have been assigned but it is also possible for less than all hosts of the cluster to be assigned to particular sub-clusters. For example, the global transport node profile 302 illustrated in FIG. 3 may be defined for a cluster 402 illustrated in FIG. 4. Cluster 402 may include hosts 110₁-110₁₂ located on racks 102₁-102₆. More specifically, hosts 110₁ and 110₃ are located on rack 102₁, hosts 110₂ and 110₄ are located on rack 102₂, hosts 110₅ and 110₇ are located on rack 102₃, etc. Rack 102₁ and rack 102₂ may be connected to a first ToR switch, and the first ToR switch may be associated with a first subnet 404 (e.g., first L3 domain/subnet). For example, the first ToR switch may be coupled to a port of a router, the port being configured to route traffic for the first subnet 404. Similarly, hosts 110₁-110₄ may be associated with the first subnet 404. Rack 102₃ and rack 102₄ may be connected to a second ToR switch, and the second ToR switch may be associated with a second subnet 406 (e.g., second L3 domain/subnet). Similarly, hosts 110₅-110₈ may be associated with the second subnet 406 Further, rack 102₅ and rack 102₆ may be connected to a third ToR switch, and the third ToR switch may be associated with a third subnet 408 (e.g., third L3 domain/subnet). Similarly, hosts 110₉-110₁₂ may be associated with the third subnet.

One or more of hosts 110₁-110₁₂ located on racks 102₁-102₆ in cluster 402 may be assigned to one or more sub-clusters. In some cases, hosts 110₁-110₁₂ may be assigned to different sub-clusters based, at least in part, on the subnet 404, 406, 408 where each of hosts 110₁-110₁₂ exist. For example, as illustrated, hosts 110₁-110₄ all exist in the first subnet 404; thus, hosts 110₁-110₄ are assigned to a first sub-cluster 410 (e.g., “Sub-Cluster 1 of Cluster 402”). Further, as illustrated, hosts 110₅-110₈ all exist in the second subnet 406; thus, hosts 110₅-110₈ are assigned to a second sub-cluster 412 (e.g., “Sub-Cluster 2 of Cluster 402”). Though aspects herein describe assigning hosts 110 to different sub-clusters based on subnets associated with each of the hosts, in certain other aspects, other properties associated with the hosts 110 may be used to assign one or more of hosts 110 to different sub-clusters (e.g., where hosts 110 assigned to a sub-cluster share at least one common property).

As mentioned above, in some cases, not all hosts 110 of the cluster are assigned to a sub-cluster. For example, as illustrated in FIG. 4, hosts 110₉-110₁₂ of Cluster-A may not be assigned to a sub-cluster.

At block 240, operations 200 proceed with associating each created sub-cluster with a defined sub-transport node profile. Associating each created sub-cluster with a defined sub-transport node profile may allow configuration parameters defined for a particular sub-transport node profile to be applied to the associated sub-cluster. For example, Sub-Cluster 1 and Sub-Cluster 2 of Cluster-A illustrated in FIG. 4 may be assigned to one of Sub-TNP1 or Sub-TNP2 illustrated in FIG. 3. For this example, at block 240, Sub-Cluster 1 is associated with Sub-TNP1, and Sub-Cluster 2 is associated with Sub-TNP2. Accordingly, when Sub-Cluster 1 is configured based on global transport node profile 302, having Sub-TNP1 and Sub-TNP2, configuration details of global transport node profile 302 and/or Sub-TNP1 may be applied to Sub-Cluster 1. Similarly, when Sub-Cluster 2 is configured based on global transport node profile 302, having Sub-TNP1 and Sub-TNP2, configuration details of global transport node profile 302 and/or Sub-TNP2 may be applied to Sub-Cluster 2.

Although operations 200 describe defining a global transport node profile and one or more sub-transport node profile prior to assigning one or more hosts of a cluster to one or more sub-clusters and associating each sub-cluster with a defined sub-transport node profile, in certain other aspects, hosts of a cluster may be separated into one or more sub-clusters prior to defining sub-transport node profiles for each of the sub-cluster. After all sub-clusters are created, or after each sub-cluster is created, a sub-transport node profile may be defined for the created sub-cluster(s) and associated with the sub-cluster(s). In other words, in certain aspects, operations at blocks 230 may occur prior to operations at blocks 210 and 220.

Further, although operations 200 describe assigning one or more hosts of the cluster to one or more sub-clusters (e.g., at block 230) and associating each sub-cluster with a defined sub-transport node profile (e.g., at block 240), alternatively in certain aspects, one or more hosts of the cluster may each be assigned to one of the sub-transport node profiles, without first assigning the one or more hosts to a sub-cluster. Further, other suitable methods for assigning hosts to sub-transport node profiles are within the scope of the disclosure, as the provided methods are only examples.

At block 250, operations 200 proceed with configuring the cluster of hosts based on the global transport node profile and the one or more sub-transport node profiles. Details for configuring the cluster of hosts based on the global transport node profile are provided in the example workflow illustrated in FIG. 2B.

As illustrated in FIG. 2B, at block 260, to configure the cluster of hosts based on the global transport node profile, each host of the cluster may be configured. In cases where none of the hosts of the cluster have been configured, the selected host at block 260, may be any host in the cluster. At block 262, operations 200 proceed with determining whether the selected host is assigned to a sub-cluster.

In cases where the host selected at block 260 is determined not to be assigned to a sub-cluster, operations 200 proceed, at block 264, by applying configuration parameters of the global transport node profile 302. For example, as illustrated in FIG. 5, in cases where the host selected at block 260 is host 110₉, only configuration parameters defined for the global transport node profile 302 may be applied to host 110₉ given host 110₉ is not assigned to a sub-cluster. As such, when the global transport node profile 302 is applied to Cluster-A, parameters of the global transport node profile 302, including “IP pool IDs” defined for global transport node profile 302, may be applied to host 110₉.

Referring to FIG. 2B, in some other cases where the host selected at block 260 is determined to be assigned to a sub-cluster, operations 200 proceed, at block 266, by determining whether configuration parameters of the global transport node profile conflict with configuration parameters of the sub-transport node profile associated with the sub-cluster. Configuration parameters of the global transport node profile may conflict with configuration parameters of the sub-transport node profile where a value for at least one configuration parameter in the global transport node profile does not match a value for the same configuration parameter in the sub-transport node profile.

In cases where the configuration parameters of the global transport node profile are determined (e.g., at block 266) not to conflict with the configuration parameters of the sub-transport node profile, operations 200 proceed, at block 268, by applying configuration parameters of both the global transport node profile and the sub-transport node profile.

In other cases where the configuration parameters of the global transport node profile are determined (e.g., at block 266) to conflict with the configuration parameters of the sub-transport node profile, operations 200 proceed, at block 270, by applying configuration parameters of the sub-transport node profile for configuration parameters determined to be conflicting between the global transport node profile and the sub-transport node profile. In other words, where configuration parameters conflict, configuration parameters of the sub-transport node profile are given higher priority (e.g., for application) than configuration parameters of the global transport node profile. For example, where both the global transport node profile and the sub-transport node profile define a value for a “VDS uplink” parameters, the value for the “VDS uplink” parameter defined in the sub-transport node profile may be applied to the host, as opposed to applying the value for the “VDS uplink” parameter defined in the global transport node profile. Further, at block 272, operations proceed by applying configuration parameters of both the global transport node profile and the sub-transport node profile.

For example, as illustrated in FIG. 5, in cases where the host selected at block 260 is host 110₁, the system determines, at block 262, that host 110₁ is assigned to sub-cluster 410 (e.g., “Sub-Cluster 1 of Cluster 402”). The system further determines, at block 266, that configuration parameters defined for the global transport node profile 302 conflict with configuration parameters defined for the first sub-transport node profile 304 (e.g., Sub-TNP1) associated with sub-cluster 410. For example, a value for “ip_pool_id” in global transport node profile 302 conflicts with a value for “ip_pool_id” in Sub-TNP1. Accordingly, at block 270, the value for “ip_pool_id” defined in Sub-TNP1 is applied to host 110₁.

Further, at block 272, values defined for “vds_uplink_name” and “uplink_name” in Sub-TNP1 are also applied to host 110₁. In particular, because global transport node profile 302 does not define a value for “vds_uplink_name” and “uplink_name”, these parameters are determined not to be conflicting and thus values for these parameters are applied to host 110₁.

Although the global transport node profile 302 illustrated in FIG. 3 illustrates sub-transport node profile 304 having parameters (e.g., “vds_uplink_name” and “uplink_name”) not defined for global transport node profile 302, in certain aspects, global transport node profile 302 may contain every parameter that may be defined for the sub-transport node profile. In other words, global transport node profile 302 may not be missing any configuration parameters that are found in defined sub-transport node profiles.

Referring to FIG. 2B, after a first selected host has been configured based on the workflow illustrated in FIG. 2B, operations 200 proceed, at block 274, by determining whether all hosts in the cluster have been configured. Where all hosts of the cluster have not been configured, another host (e.g., that has not been configured) is selected block 260. Alternatively, where all hosts of the cluster have been configured, operations 200 are complete. As such, hosts of the host cluster may be configured with a similar configuration and/or different configurations among hosts of the cluster.

While FIG. 2B illustrates one method for configuring hosts of the cluster based on a global transport node profile and one or more sub-transport node profile, in certain other aspects, the global transport node profile may be applied to all hosts of the cluster irrespective of whether or not one or more parameters of different sub-transport node profiles (e.g., associated with different sub-clusters of hosts) conflict with one or more parameters defined in the global transport node profile. After applying the global transport node profile, sub-transport node profiles may be applied to their corresponding sub-cluster of hosts. Where a sub-transport node profile contains one or more parameters which conflict with the parameters of the global transport node profile, parameters of the sub-transport node profile may override previously configured parameters for hosts in the sub-cluster associated with the sub-transport node profile. Other methods for configuring hosts of the cluster based on a global transport node profile and one or more sub-transport node profile are also possible and within the scope of the disclosure, as the provided methods are only examples.

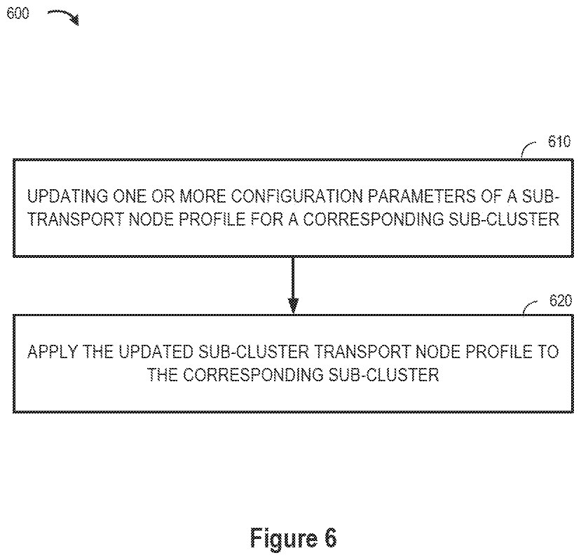

In certain aspects, after hosts of the cluster have been configured based on the global transport node profile, a user and/or administrator may desire to change the configuration for one or more hosts in the cluster. The global transport node profile having sub-transport node profiles defined therein provides a single location for a user and/or administrator to make such a change to one or more hosts of the cluster. In some cases, the change may be made to hosts belonging to a previously created sub-cluster. FIG. 6 is a flow diagram illustrating example operations 600 for updating the configuration applied to hosts belonging to a previously-created sub-cluster, according to one or more aspects of the present disclosure.

Operations 600 begin, at block 602, by updating one or more parameters (e.g., existing and/or new parameters) of a sub-transport node profile. For example, a user and/or administrator may desire to change an IP address pool range for hosts of the cluster existing in the second subnet (e.g., second L3 domain/subnet #2), as illustrated in FIG. 4 (e.g., hosts 110₅-110₈). Accordingly, the user and/or administrator may change of a value of “ip_pool_id” in Sub-TNP2 associated with the second sub-cluster, given hosts 110₅-110₈, existing in the second subnet, were previously assigned to the second sub-cluster.

At block 604, operations 600 proceed by applying the update sub-transport node profile to the corresponding cluster. For example, using the above example, Sub-TNP2 updated with the new IP address pool range may be applied to hosts 110₅-110₈.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these operations may require physical manipulation of physical quantities-usually, though not necessarily, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments may be useful machine operations. In addition, one or more embodiments also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments may be implemented as one or more computer programs or as one or more computer program modules embodied in one or more computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

What is claimed is:

1. A method for configuring a cluster of hosts, comprising:
defining and storing a global transport node profile that defines a first configuration for the cluster of hosts;
defining and storing a sub-transport node profile that defines a second configuration;
assigning one or more hosts of the cluster to the sub-transport node profile; and
configuring the cluster of hosts based on the global transport node profile and the sub-transport node profile comprising:
configuring the one or more hosts of the cluster based on the first configuration and the second configuration; and
configuring at least one host of the cluster not assigned to the sub-transport node profile based on the first configuration and not the second configuration.

2. The method of claim 1, wherein assigning the one or more hosts of the cluster to the sub-transport node profiles comprises:
assigning the one or more hosts of the cluster to a sub-cluster, wherein the sub-cluster comprises hosts that share a common property; and
associating the sub-cluster with the sub-transport node profile.

3. The method of claim 2, wherein the common property comprises a subnet common among each of the hosts.

4. The method of claim 1, wherein configuring the cluster of hosts based on the global transport node profile and the sub-transport node profile comprises, for each host of the cluster:
determining whether the host is assigned to the sub-transport node profile;
when the host is assigned to the sub-transport node profile:
applying the first configuration defined by the global transport node profile and the second configuration defined by the sub-transport node profile assigned to the host; and
when the host is not assigned to the sub-transport node profile:
applying the first configuration defined by the global transport node profile to the host.

5. The method of claim 4, wherein applying the first configuration defined by the global transport node profile and the second configuration defined by the sub-transport node profile comprises:
determining configuration parameters of the first configuration do not conflict with configuration parameters of the second configuration; and
applying both the configuration parameters of the first configuration and the configuration parameters of the second configuration to the host.

6. The method of claim 4, wherein applying the first configuration defined by the global transport node profile and the second configuration defined by the sub-transport node profile comprises:
determining at least one configuration parameter is defined in both the first configuration and the second configuration;
determining a first value of the at least one configuration parameter in the first configuration conflicts with a second value of the at least one configuration parameter in the second configuration; and
applying the second value of the at least one configuration parameter to the host.

7. The method of claim 1, wherein each of the first configuration and the second configuration define configuration parameters that comprise at least one of:
virtual switches;
virtual switch configurations;
transport zones;
network input/output configurations;
uplink profiles; or
internet protocol pool addresses.

8. A system comprising:
one or more processors; and
at least one memory, the one or more processors and the at least one memory configured to:
define and store a global transport node profile that defines a first configuration for the cluster of hosts;
define and store a sub-transport node profile that defines a second configuration;
assign one or more hosts of the cluster to the sub-transport node profile; and
configure the cluster of hosts based on the global transport node profile and the sub-transport node profile, wherein to configure the cluster of hosts comprises to:
configure the one or more hosts of the cluster based on the first configuration and the second configuration; and
configure at least one host of the cluster not assigned to the sub-transport node profile based on the first configuration and not the second configuration.

9. The system of claim 8, wherein to assign the one or more hosts of the cluster to the sub-transport node profiles comprises to:
assign the one or more hosts of the cluster to a sub-cluster, wherein the sub-cluster comprises hosts that share a common property; and
associate the sub-cluster with the sub-transport node profile.

10. The system of claim 9, wherein the common property comprises a subnet common among each of the hosts.

11. The system of claim 8, wherein to configure the cluster of hosts based on the global transport node profile and the sub-transport node profile comprises to, for each host of the cluster:
determine whether the host is assigned to the sub-transport node profile;
when the host is assigned to the sub-transport node profile:
apply the first configuration defined by the global transport node profile and the second configuration defined by the sub-transport node profile assigned to the host; and
when the host is not assigned to the sub-transport node profile:
apply the first configuration defined by the global transport node profile to the host.

12. The system of claim 11, wherein to apply the first configuration defined by the global transport node profile and the second configuration defined by the sub-transport node profile comprises to:
determine configuration parameters of the first configuration do not conflict with configuration parameters of the second configuration; and
apply both the configuration parameters of the first configuration and the configuration parameters of the second configuration to the host.

13. The system of claim 11, wherein to apply the first configuration defined by the global transport node profile and the second configuration defined by the sub-transport node profile comprises to:
determine at least one configuration parameter is defined in both the first configuration and the second configuration;
determine a first value of the at least one configuration parameter in the first configuration conflicts with a second value of the at least one configuration parameter in the second configuration; and
apply the second value of the at least one configuration parameter to the host.

14. The system of claim 8, wherein each of the first configuration and the second configuration define configuration parameters that comprise at least one of:
virtual switches;
virtual switch configurations;
transport zones;
network input/output configurations;
uplink profiles; or
internet protocol pool addresses.

15. A non-transitory computer-readable medium comprising instructions that, when executed by one or more processors of a computing system, cause the computing system to perform operations for configuring a cluster of hosts, the operations comprising:
defining and storing a global transport node profile that defines a first configuration for the cluster of hosts;
defining and storing a sub-transport node profile that defines a second configuration;
assigning one or more hosts of the cluster to the sub-transport node profile; and
configuring the cluster of hosts based on the global transport node profile and the sub-transport node profile comprising:
configuring the one or more hosts of the cluster based on the first configuration and the second configuration; and
configuring at least one host of the cluster not assigned to the sub-transport node profile based on the first configuration and not the second configuration.

16. The non-transitory computer-readable medium of claim 15, wherein assigning the one or more hosts of the cluster to the sub-transport node profiles comprises:
assigning the one or more hosts of the cluster to a sub-cluster, wherein the sub-cluster comprises hosts that share a common property; and
associating the sub-cluster with the sub-transport node profile.

17. The non-transitory computer-readable medium of claim 16, wherein the common property comprises a subnet common among each of the hosts.

18. The non-transitory computer-readable medium of claim 15, wherein configuring the cluster of hosts based on the global transport node profile and the sub-transport node profile comprises, for each host of the cluster:
determining whether the host is assigned to the sub-transport node profile;
when the host is assigned to the sub-transport node profile:
applying the first configuration defined by the global transport node profile and the second configuration defined by the sub-transport node profile assigned to the host; and
when the host is not assigned to the sub-transport node profile:
applying the first configuration defined by the global transport node profile to the host.

19. The non-transitory computer-readable medium of claim 18, wherein applying the first configuration defined by the global transport node profile and the second configuration defined by the sub-transport node profile comprises:
determining configuration parameters of the first configuration do not conflict with configuration parameters of the second configuration; and
applying both the configuration parameters of the first configuration and the configuration parameters of the second configuration to the host.

20. The non-transitory computer-readable medium of claim 18, wherein applying the first configuration defined by the global transport node profile and the second configuration defined by the sub-transport node profile comprises:
determining at least one configuration parameter is defined in both the first configuration and the second configuration;
determining a first value of the at least one configuration parameter in the first configuration conflicts with a second value of the at least one configuration parameter in the second configuration; and
applying the second value of the at least one configuration parameter to the host.
